(19) United States
(12) Patent Application Publication
(10) Pub. No.: US 2004/0234347 A1
(43) Pub. Date: Nov. 25, 2004

(54) Self supported rasp blade

(76) Inventor: Anthony Collins, Belmont (AU)

Correspondence Address: Edwin D Schindler, Five Hirsch Avenue, P.O. Box 966, Coram, NY, 11727-0966, US

(21) Appl. No.: 10/843,746

(22) Filed: May 12, 2004

(30) Foreign Application Priority Data
May 21, 2003 (AU) 2003902508

(51) Int. Cl. B23D 71/00

(52) U.S. Cl. 407/29.12

(57) ABSTRACT

A rasp blade 10 includes a planar sheet 12 with inner perimeter 14 and outer perimeter 16, the latter defined by the tips of a row of teeth 18. The teeth 18 extend from left side edge 20 to right side edge 22. The tips of the teeth 18 are arranged along a line of constant radius from centre 28 with the pitch of the teeth and their height from the baseline 17 (dotted line) varying from left to right. The variation can be a continuous or a variable increase along the arcuate extent of the blade. The blade has three apertures 30 for supporting the blade on pins running between end plates of a hub assembly. The blade can extend over an arc of approximately 30° up to 120° with the number of apertures depending on the arcuate extent of the blade. The blade can also include projections 40 which can be punched or pressed from the planar sheet 12 forming hollow frustro-conical extensions of the planar sheet 12 or projections 40 can be fixed separately as hollow or solid members. The tops 42 of respective projections 40 of adjacent blades provide abutting surfaces to space apart adjacent blades in a hub assembly. The top 42 can be flat, curved, round, or indented. The teeth are presented at various slant angles in a hub assembly whereby a better abrading surface is provided. Further worn blades having projections 40 can be used as spacers.

### FIELD OF THE INVENTION

The present invention relates to a rasp blade for buffing the tread from tyres with the rasp blade having teeth of varying size and varying pitch across the extent of the blade and/or having means integral with the blade for spacing apart adjacent rasp blades.

### BACKGROUND OF THE INVENTION

In the prior art, rasp blades and spacer elements are employed to form a rasp blade hub assembly for the buffing of the tread from worn motor vehicle tyres before they are retreaded. Hence, an inventory of blades and spacer elements is required to maintain proper functioning of a hub assembly. In the prior art, for example, the rasp blade described in U.S. Pat. No. 6,554,547, an improved buffing arrangement is provided by offsetting the teeth one quarter pitch from one edge of the blade allowing adjacent rows of blades to be formed in a staggered arrangement whereby, with this teeth arrangement, a more uniform buffing of the surface of a tyre can be provided.

The present invention seeks to provide an alternative to or to overcome disadvantages in these prior art arrangements and in particular to provide a rasp blade with improved characteristics.

### SUMMARY OF THE INVENTION

According to the invention there is provided a rasp blade including an arcuate substantially planar sheet extending between an inner perimeter and an outer perimeter, said outer perimeter being defined by tips of a row of teeth, said tips being of a constant radius from a predetermined centre, said teeth extending along said outer perimeter of said rasp blade and being of a variable height and pitch, and means for supporting said rasp blade in a hub assembly.

Preferably, the teeth vary in height from a given datum and in pitch from one side to the other of said rasp blade. Preferably, the rasp blade is supported in a hub assembly by pins passing through apertures in the rasp blade. Preferably, there are three apertures per blade.

Preferably, a rasp blade has an arcuate extent of 90° whereby 4 rasp blades can be arranged about the axis of a hub assembly and stacked to form rows of blades as is well known in the art. The blade is supported on pins extending between end plates with spacer elements, as known in the art, separating the rasp blades in adjacent rows.

Alternatively, according to a further aspect of the invention there is provided a rasp blade including an arcuate substantially planar sheet extending between an inner perimeter and an outer perimeter, said outer perimeter being defined by tips of a row of teeth, said tips being of a constant radius from a predetermined centre, said teeth extending along said outer perimeter of said rasp blade and being of a variable height and pitch, means for supporting said rasp blade in a hub assembly and further including spacing means for holding said rasp blade in spaced relation from an adjacent such rasp blade in a hub assembly said spacing means being fixed to and extending from said rasp blade at a plurality of positions along the arcuate extent of said rasp blade.

Preferably, said spacing means include two, three or four projections extending from said rasp blade. For example, said projections may be formed by punching or extruding a section of the planar sheet of said rasp blade. Preferably, a rasp blade having three apertures for supporting the blade on pins therethrough, has four projections provided arranged approximately equidistant from the respective apertures.

### BRIEF DESCRIPTION OF THE DRAWINGS

Preferred embodiments of the invention will now be described with respect to the following figures in which:

FIG. 1 shows a first embodiment of a rasp blade according to the invention;

FIG. 2 shows the rasp blade of FIG. 1 in greater detail;

FIG. 3 shows a pair of rasp blades of FIG. 1 with teeth aligned;

FIG. 4 shows a pair of rasp blades of FIG. 1 with teeth in reversed order;

FIG. 5 shows the arrangement of FIG. 4 in perspective view from underneath;

FIG. 6 shows the pair of rasp blades of FIG. 5 with spacers; and

FIG. 7.shows a rasp blade according to a second embodiment of the invention.

### DETAILED DESCRIPTION OF THE EMBODIMENT OR EMBODIMENTS

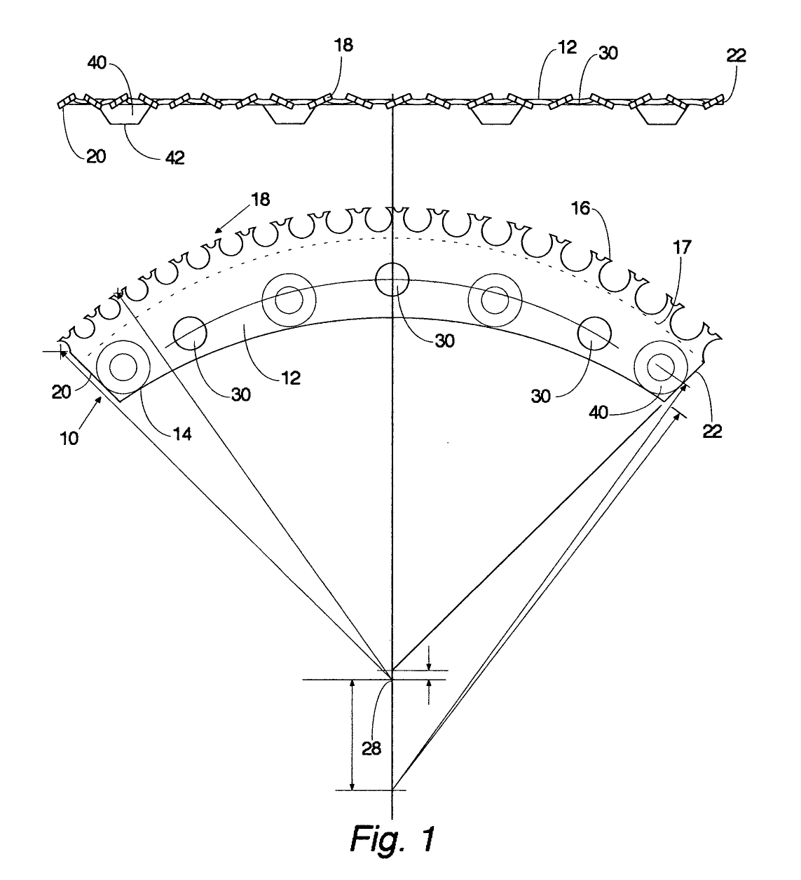

Referring to FIG. 1, a rasp blade 10 according to a first aspect of the invention includes a planar sheet 12 defined between an inner perimeter 14 and an outer perimeter 16. The perimeter 16 is defined by the tips of a row of teeth 18 with the teeth 18 extending from a first side edge 20 to a second side edge 22. The tips or outer cutting edge of the teeth are arranged along a line of constant radius from a centre 28 with the pitch of the teeth and their height from the baseline 17 (dotted line) varying from the left hand edge 20 to the right hand edge 22. For the embodiment shown in FIG. 1, the variation is a continuous increase from left to right. The pitch of the teeth refers to the separation between a feature of a tooth formation and the equivalent feature of the next adjacent tooth formation along the arcuate extant of the blade. The height of the tooth refers to the distance from the tip of the tooth to the baseline 17.

The planar section 12 of the blade has, in this case, three apertures 30 for supporting the blade on pins running between end plates of a hub assembly as is well known in the art. The blade of FIG. 1 extends over an arc of approximately 900 ° whereby four such blades can be arranged about the axis of a hub assembly in which the blade is to be used. Blades of other arcuate extent are also contemplated. In particular, the arcuate range can vary from 300 ° up to 1200° . The number of apertures will vary depending on the arc over which the blade extends. It is preferred that at least three apertures be provided per blade. in order to ensure a safer arrangement when the rasp blades are stacked in a hub assembly, for example, should one of the pins break. Notwithstanding, a minimum of a pair of apertures will suffice.

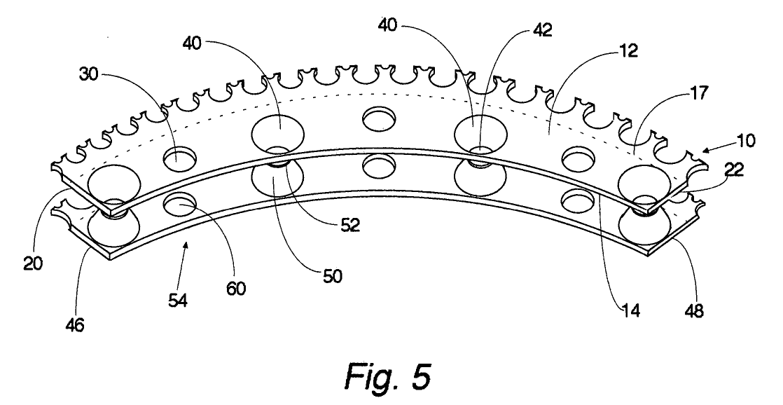

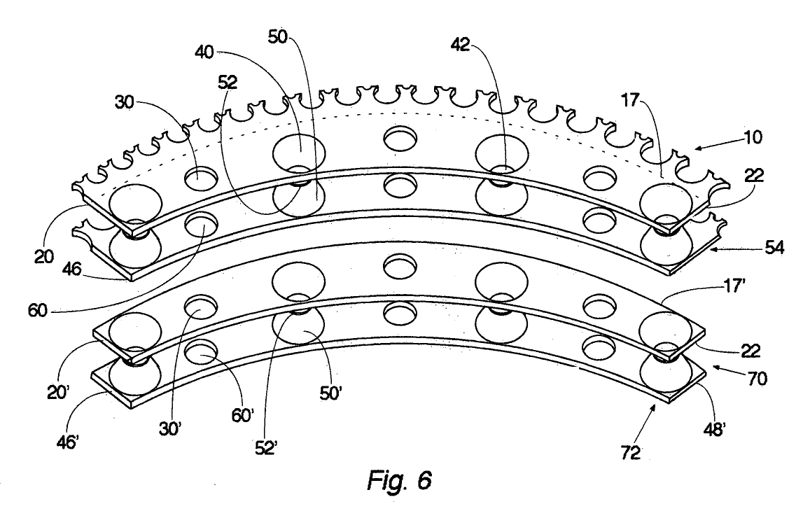

As shown in FIG. 1, and in particular as shown in plan view, projections 40 are provided with the apertures 30 located between each pair of projections 40 making four projections 40 for the rasp blade. The projections 40 can be punched or pressed from the planar sheet 12 of the rasp blade during manufacture forming hollow, as shown in plan view, frustro-conical extensions of the planar sheet 12. The centres of the projections 40 are located below the centres of the apertures 30. The top 42 of the projections 40 provides a surface which can more readily abut a similar top of a projection of an adjacent blade to thereby space apart adjacent blades, such as shown in FIGS. 5 and 6. The top 42 may be flat, curved, round, or indented within the knowledge of a person skilled in the art.

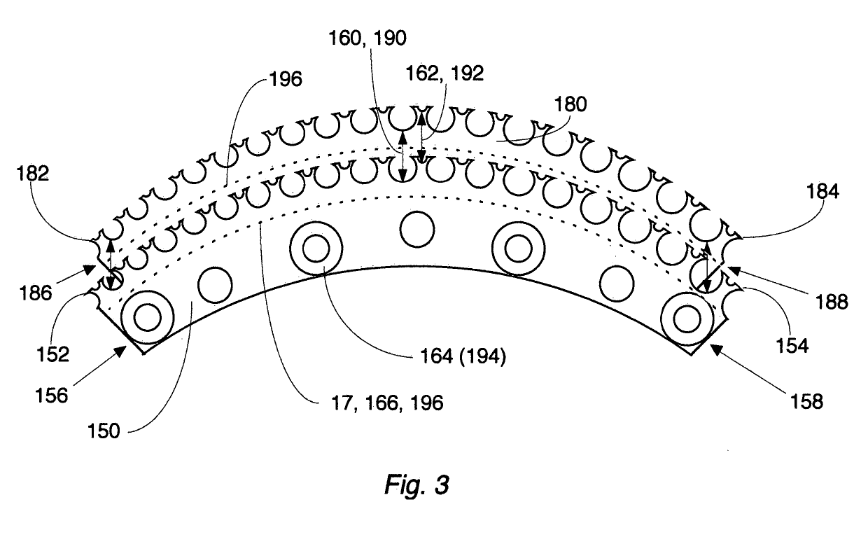

Referring to FIG. 3, two blades 150, 180 are arranged in a parallel configuration with smallest teeth 152,182, and largest teeth 154, 184 at aligned ends 156, 186 and 158, 188, respectively. Thus the troughs 160, 190 and the crests 162, 192 of the teeth of each blade are aligned.

The projections 164, 194 are aligned and as they are hollow, adjacent blades 150, 180 require a further spacer element to space them apart. Such a spacer can be made from a blade such as described herein but with the teeth removed by cutting along the baseline 17, 166 or 196. Alternatively, a spacer element such as known in the prior art can be used. If the projections are solid then no further spacing element would be required, the projections providing the necessary spacing between adjacent parallel blades, for this configuration.

Referring to FIG. 5, a first blade 10, having the features of FIG. 1, has teeth extending from left to right of the drawing varying in pitch and height in the manner of FIG. 1, namely, with the smallest pitch and smallest height adjacent edge 20 (left side) and the largest pitch and largest height of the teeth adjacent edge 22 (right side). The second blade 54 has a blade much as described in FIG. 1 but with the blade in a reversed or mirror image whereby the teeth of small pitch and small height are located at the edge 46 (right side) and the teeth of larger height and larger pitch at the end 48 (left side). The projections 50 of the blade 54 now project towards the projections 40 of the blade 10 whereby the respective tops 42 and 52 can abut. In this way the projections 40, 50 provide spacing of the blades 10, 54. Additionally, this spacing allows air to circulate between the blades aiding cooling thereof. Equally, the apertures 30, 60 are aligned so that the blades 10,54 maybe supported in a hub assembly by pins therethrough. In this way, no separate spacer element is required in order to keep the rasp blades 10, 54 in the right relative positions as required in a hub assembly. The rasp blades 10, 54 thus perform the function both of a blade and of a spacer element.

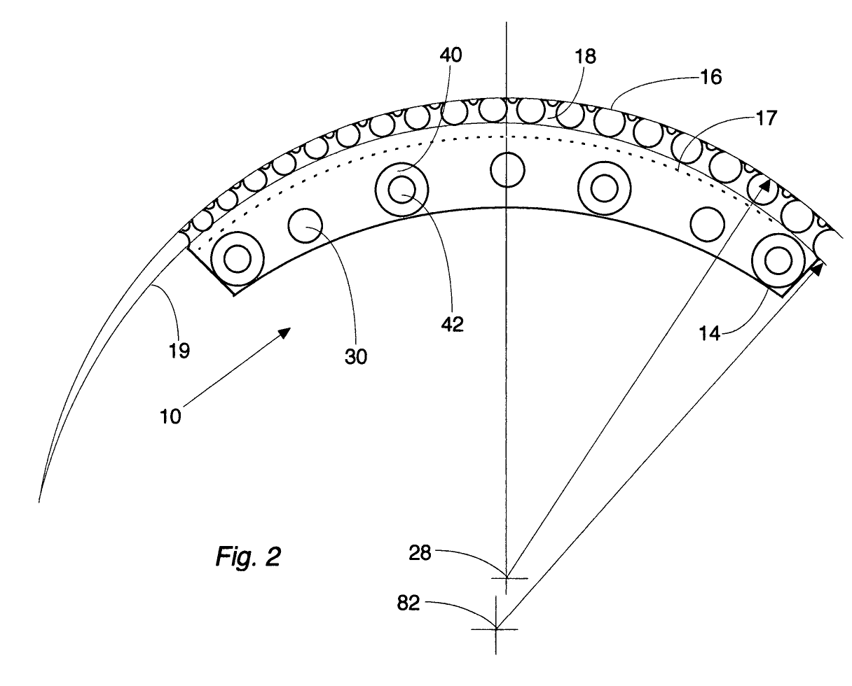

Alternatively, as shown in FIG. 6, a rasp blade may be converted to a spacer element by cutting along the baseline 17, for example, as shown in the lower part of the figure as elements 70, 72. Parts of the elements 70, 72 similar to those of respective blades 10, 54 are of identical numbering but marked by an “′” . The elements 70, 72 may be made after a blade has reached the end of its practical life or during manufacture. In the former case, in time a smaller number of separate spacer elements is required as old rasp blades can be recycled for this purpose. Referring to FIG. 2, the geometry of the rasp blade, as shown by the embodiment of FIG. 1, is demonstrated. As previously stated, the tips of the teeth follow a curve of constant radius from the centre 28 of a hub assembly axis. The baseline 17 is defined by an arc having a constant radius of lesser curvature from the centre 28 of a hub assembly axis while the base 19 of the teeth formations is defined by a curve having a non-constant curvature from centre or origin 82, which is offset from the hub axis 28 in the embodiment shown, by 0.090 inches (0.23 millimetres). For example, the base 19 may be formed on an ellipsoidal curve. This 0.09 inches offset provides a gap or clearance between adjacent blades when stacked in a hub assembly to avoid blades sticking together. The teeth 18 extend between the base 19 and the outer perimeter 16. The blade shown in FIG. 1 is of a standard 9″ diameter with the baseline 17 of the teeth located on a radius of 4.214 inches (107 millimetres) with the outer perimeter 16 located on a radius of 4.500 inches (114.3 millimetres). For the example shown, the base 19 of the teeth 18 is on an ellipse with minor axis diameter 9.030 inches (229.4 millimetres) and major axis diameter 9.560 inches (252.8 millimetres) from the centre 82. The teeth 18 are of a dual crown form.

The typical dimensions for a blade of 9″ diameter as shown in FIG. 1 are shown in Table 1 of Appendix A. These dimensions are intended to be illustrative only and not limiting on the scope of the invention.

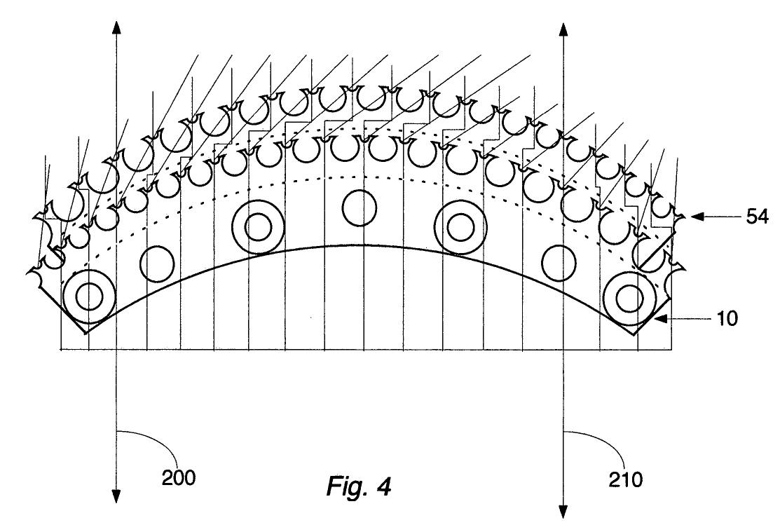

In the embodiment shown in FIG. 1, in which the projections are arranged to one side of the blade, the configuration shown in FIG. 5 is possible. This arrangement is shown also in FIG. 4 which shows the various slant angles of the teeth positions of a pair of adjoining blades for this configuration. Only two pairs 200, 210 of rows of teeth are directly aligned in this configuration with all other teeth at varying slant angles from left to right across the arcuate extent of the blades. A lack of uniform presentation of the blades, namely, that the teeth are presented at various slant angles means that the hub assembly comprised of such blades would present a better abrading surface for the buffing of motor vehicle tyre treads. In this configuration while a pair of adjacent blades may act as mutually spaced elements, the addition of further blades in a stack requires additional spacing elements such as shown in FIG. 6. Conventional spacer means may also be used.

For the embodiment shown in FIG. 3, where the adjoining blades are arranged with the small teeth and the large teeth at the same ends of the blades, a separate arrangement is required.

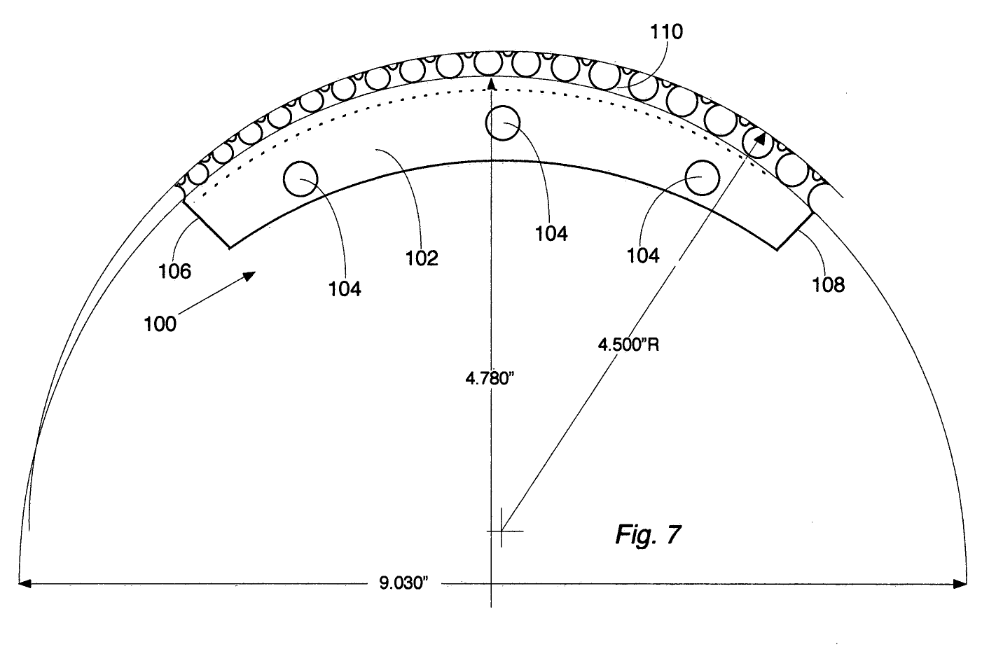

As shown in FIG. 7, an alternative embodiment of the invention is shown wherein the rasp blade has all the features of the embodiment of FIG. 1 except for the projections 40. The blade 100, as shown in FIG. 7, is a planar sheet 102 with apertures 104. The embodiment shown in FIG. 7 has the same variation in pitch and height of the teeth 1 10 from one end 106 of the blade 100 to the other 108 as has been described above with respect to the embodiment of FIG. 1. Pins through the apertures 104 in the blade 100 enable the teeth to be aligned in a parallel or anti-parallel configuration as shown in FIG. 3 or FIG. 4. The blade 100 can be used on its own with spacers known in the prior art or with elements 70, 72 as illustrated in FIG. 6, or in combination with blades of the embodiment illustrated in FIG. 1 mutatis mutandis.

For the embodiment shown in FIG. 1, it was stated that the projections 40 may be formed by punching or extrusion from the planar sheet 12. Alternatively, the frustro-conical extensions may be otherwise formed on the planar sheet 12 such as by being welded or adhesively bonded thereto. In this case, there is no requirement for additional spacer elements in a parallel array of such blades. A series of rows of blades may be stacked spaced apart by the respective frustro-conical extensions on each blade. Thus, the implementation of the configuration of FIG. 3 can be done using a single type of blade with rows of blades stacked with the blades facing in the same direction. For the embodiment of FIG. 4, there will still be a need to provide some spacer elements between pairs of rows of blades.

For the embodiment of FIG. 7 the method of manufacture, employed in the prior art can be adapted to produce a blade with the teeth as required. For the embodiment of FIG. 1 or such embodiments in which projections are provided then the process of the prior art can be modified whereby the projections are produced subsequent to the blade being otherwise produced either by punching or by the protusions being welded or adhesively bonded or otherwise fixed to the blade.

Although the invention has been described above with respect to preferred embodiments thereof, variations therein are contemplated within the knowledge of a person skilled in the art.

[image]

We claim

1. A rasp blade including an arcuate substantially planar sheet extending between an inner perimeter and an outer perimeter, said outer perimeter being defined by tips of a row of teeth, said tips being of a constant radius from a predetermined centre, said teeth extending along said outer perimeter of said rasp blade and being of a variable height and pitch, and means for supporting said rasp blade in a hub assembly.

2. A rasp blade as claimed in claim 1 wherein the teeth vary in height from a given datum and in pitch from one side to the other of said rasp blade.

3. A rasp blade as claimed in claim 1 wherein the rasp blade is supported in a hub assembly by pins passing through apertures in the rasp blade.

4. A rasp blade as claimed in claim 3 wherein there are three apertures per blade.

5. A rasp blade as claimed in claim 1 wherein said rasp blade has an arcuate extent of 90° whereby 4 rasp blades can be arranged about the axis of a hub assembly and stacked to form rows of blades and the blade is supported on pins extending between end plates with spacer elements separating the rasp blades in adjacent rows.

6. A rasp blade including an arcuate substantially planar sheet extending between an inner perimeter and an outer perimeter, said outer perimeter being defined by tips of a row of teeth, said tips being of a constant radius from a predetermined centre, said teeth extending along said outer perimeter of said rasp blade and being of a variable height and pitch, means for supporting said rasp blade in a hub assembly and further including spacing means for holding said rasp blade in spaced relation from an adjacent such rasp blade in a hub assembly, said spacing means being fixed to and extending from said rasp blade at a plurality of positions along the arcuate extent of said rasp blade.

7. A rasp blade as claimed in claim 6 wherein said spacing means include two, three or four projections extending from said rasp blade.

8. A rasp blade as claimed in claim 7 wherein said projections may be formed by punching or extruding a section of the planar sheet of said rasp blade.

9. A rasp blade as claimed in claim 7 wherein said rasp blade has three apertures for supporting the blade on pins therethrough, and four projections provided arranged approximately equidistant from the respective apertures.
